(19) United States
(12) Patent Application Publication
(10) Pub. No.: US 2012/0118735 A1
(43) Pub. Date: May 17, 2012

(54) ELECTROCHEMICAL BIOSENSOR ELECTRODE STRIP AND PREPARATION METHOD THEREOF

(76) Inventors: Seok-Hun Kim, Gyeonggi-do (JP); Eui-Gun Kim, Seoul (KR)

(21) Appl. No.: 13/264,399

(22) PCT Filed: Apr. 19, 2010
(86) PCT No.: PCT/US10/31563

§ 371 Date: Jan. 30, 2012

(30) Foreign Application Priority Data
Apr. 24, 2009 (KR) 10-2009-0035775

(51) Int. Cl. G01N 27/327; B05D 3/00; B05D 5/12

(52) U.S. Cl. 204/403.02; 427/122

(57) ABSTRACT

Disclosed is an electrode strip for an electrochemical biosensor, which is fabricated by forming a nickel-including metal layer on a non-conductive substrate including a polymer material, forming a carbon layer thereon, and carrying out patterning.

### BACKGROUND

The present invention relates to an electrochemical biosensor electrode strip which has a low fabrication cost and yet has excellent performance, and a method for fabricating the same. More particularly the present invention relates to an electrode strip for an electrochemical biosensor test strip, which is for quantitatively analyzing a specific substance in a biological sample, for example, glucose in blood, and a method for fabricating the same.

In the medical field, an electrochemical biosensor has recently been frequently used to analyze biological samples, including blood. Especially, an electrochemical biosensor using an enzyme is being widely used at present, due to its ease in application, high measurement sensitivity, and capability of quickly making a result.

To such an electrochemical biosensor, an enzyme analysis is applied. The enzyme analysis is divided into, according to a detection method, a chromophoric method (a spectroscopic way) and an electrode method (an electrochemical way).

First, the chromophoric method is for analyzing a biological sample by observing an indicator color's change caused by a reaction of the biological sample with an enzyme. However, in the chromophoric method, it is difficult to accurately carry out the measurement because the measurement is based on the degree of discoloration. Also, the chromophoric method requires a longer measuring time than the electrode method, and is accompanied by difficulty in analyzing an important biological material due to the measurement error because of the turbidity of the biological sample.

Accordingly, an electrode method, in which an electrode system for measuring a biological sample is previously formed, an analysis reagent is immobilized onto the electrode, and the biological sample is introduced thereto, has recently been frequently applied to an electrochemical biosensor. In this method, the current/voltage are measured by applying a predetermined potential, and thereby a specific substance in the sample is quantitatively measured.

Hereinafter, the operation principle of a blood sugar level-measuring biosensor, one example of such an electrochemical biosensor, will be described.

In the blood sugar level-measuring biosensor, a certain electrode is formed, and then a glucose oxidase, as an analysis reagent, is immobilized onto a part of the electrode to form a reaction layer. When a blood sample is introduced to the reaction layer, the blood sugar is oxidized by the glucose oxidase and the glucose oxidase is reduced. An electron acceptor oxidizes the glucose oxidase and reduces itself. The reduced electron acceptor loses its electrons and is electrochemically re-oxidized on an electrode surface with a predetermined voltage applied thereto. Since the concentration of glucose within the blood sample is in proportion to the amount of current generated by the oxidization process of the electron acceptor, the concentration of blood sugar can be measured by measuring the current amount.

By the use of such an electrochemical biosensor, it is possible to measure uric acid and protein as well as glucose within blood, and also to measure enzyme activity of GOT (Glutamate-Oxaloacetate Transaminase) or GPT (Glutamate-Pyruvate Transaminase) in DNA and liver function tests.

Herein, the biosensor is divided into an identification portion for identifying an object to be measured, and a conversion portion for performing conversion into an electrical signal. In the identification portion, a biological material is used, and the biological material's identification of the object to be measured makes a chemical or physical change. Such a change is converted into an electrical signal in the conversion portion which is commonly referred to as an electrode for a biosensor.

One of the fabrication methods of such a biosensor electrode is silk printing. Silk printing is a printing method using platinum, carbon, or silver/silver chloride ink, which requires a low equipment cost but has a problem in that the adjustment of the resistance variation is difficult for the fabrication of a sensor electrode requiring reproducibility.

There is another method of fabricating a biosensor electrode, which is vacuum deposition or sputtering method using a patterned mask and noble metals to form electrode patterns. In this fabrication method, a patterned mask is laid on a substrate, and vacuum deposition or sputtering is performed thereon using noble metals. The use of an expensive noble metal has problems in that a high cost is required and the noble metal is difficult to recover, and the burden of an increase in the unit cost of production is imposed in order to greatly reduce electrode resistance.

In addition, according to a conventional sputtering method using patterned mask, sputtering was performed in sheet type, and thus the efficiency was not so high.

Meanwhile, a metal patterning technology which has been conventionally used for fabricating a printed circuit board (PCB), may also be applied to the fabrication of an electrode for an electrochemical biosensor for quantifying a specific substance in a biological sample such as blood.

However, in conventional PCB fabrication where an electrode is fabricated by using copper, etc., the layering of metal on the copper substrate generates a non-uniform and lumpy surface, and the sample flows into the underlayer of the copper, thereby generating an electrical signal disturbing the measurement value. Thus, this method is inappropriate for the application to fabrication of the biosensor electrode. Moreover, copper or nickel used in the PCB is electroactive (that is, unstable) at a voltage conventionally used in the electrochemical biosensor, and thus is inappropriate as an electrode material for the electrochemical biosensor.

Meanwhile, conventionally, in order to form an electrode pattern on a substrate, such as a plastic film, a method for adhering a thick-film wire including copper with palladium deposited thereon by heat, etc., or another method for screen-printing a liquid-phase electrode material, has been used.

However, in the method of adhering the thick-film wire on the substrate, such as a plastic film, it is difficult to make narrow and sharp thick-film wire by using copper with palladium deposited thereon. Because narrow and sharp electrode is not made by the thick-film wire method, the detection efficiency is limited. Also, palladium used as an electrode material is very expensive, and generates a large fraction of undesired current due to its high reactivity with an interfering substance. Moreover, the thick-film wire has a problem in that the electrode easily detaches from the plastic film due to the wire's weak adhesive force with a plastic film.

Meanwhile, the method of screen-printing a liquid-phase electrode material requires a liquid-phase plating solution. Especially, in order to form an electrode by using a material having a high detection effect and high chemical resistance, such as gold, palladium, platinum, a very expensive liquid-phase plating solution is required. Therefore, due to the limitation of usable materials, carbon is mainly used. However, an electrode strip formed by the screen-printing of carbon has a problem in that its surface is very non-uniform and thus causes a low detection property.

Meanwhile, gold is known to have the least reactivity with an interfering substance in an electrochemical reaction, and the best chemical resistance. However, in general, an electrode made as a very thin plate is attached or a liquid-phase electrode material is attached by screen-printing, and thus the thickness of an electrode strip for a biosensor increases. Accordingly, when gold is adhered in this manner, production cost increases greatly.

### SUMMARY

Accordingly, the present invention has been made to solve the above-mentioned problems occurring in the prior art, and the present invention provides an improved electrochemical biosensor electrode and a method of fabricating the same.

It is an object of the present invention to provide an electrochemical biosensor electrode and a method of fabricating the same, which can reduce the fabrication time and cost by using fewer components and simplifying the fabrication process.

It is another object of the present invention to provide an electrochemical biosensor electrode and a method of fabricating the same, which can show an excellent electrical property without using an expensive precious metal.

It is a further object of the present invention to provide an electrochemical biosensor electrode which can be appropriately transformed as required and have an excellent detection property due to its capability of being patterned into a required shape with uniform surface, and a method of fabricating the same.

Therefore, the present invention provides an electrode strip to be used for an electrochemical biosensor, which requires low production cost and has excellent performance.

In accordance with an aspect of the present invention, there is provided an electrode strip for an electrochemical biosensor, the electrode strip including: a strip-shaped non-conductive substrate; and at least two electrodes operating as a working electrode and a reference electrode, which are provided on the substrate, wherein the electrodes include a metal layer and a carbon layer, in which the metal layer is provided on the substrate, the carbon layer is provided on the metal layer, and the metal layer includes nickel (Ni).

In accordance with another aspect of the present invention, there is provided a method of fabricating an electrode strip for an electrochemical biosensor, the method including the steps of: preparing a non-conductive substrate; forming a nickel-including metal layer on the substrate; forming a carbon layer on the formed metal layer, thereby forming a conductive layer including the metal layer and the carbon layer; and patterning an electrode shape by partially etching the conductive layer.

### BRIEF DESCRIPTION OF THE DRAWINGS

The above and other objects, features and advantages of the present invention will be more apparent from the following detailed description taken in conjunction with the accompanying drawings, in which:

FIG. 1 is a view schematically illustrating a fabrication process of an electrochemical biosensor electrode strip according to one embodiment of the present invention;

FIG. 2 is a top view illustrating electrode disposition of the electrode strip fabricated by the process as shown in FIG. 1;

FIG. 3 is a sectional view illustrating the electrode strip fabricated by the process as shown in FIG. 1, which was taken along the direction indicated by the line A-A′ as shown in FIG. 2;

FIG. 4 is a sectional view illustrating the electrode strip fabricated by the process as shown in FIG. 1, which was taken along the direction indicated by the line B-B′ as shown in FIG. 2; and

FIGS. 5 to 7 are views showing different embodiments of the electrochemical biosensor electrode strip according to the present invention.

### DETAILED DESCRIPTION

Hereinafter, an electrochemical biosensor electrode strip according to the present invention and a method of fabricating the same will be described in more detail with reference to the accompanying drawings.

However, the description is illustrative only for the purpose of the explanation of the present invention, and the scope of the present invention is not limited thereto.

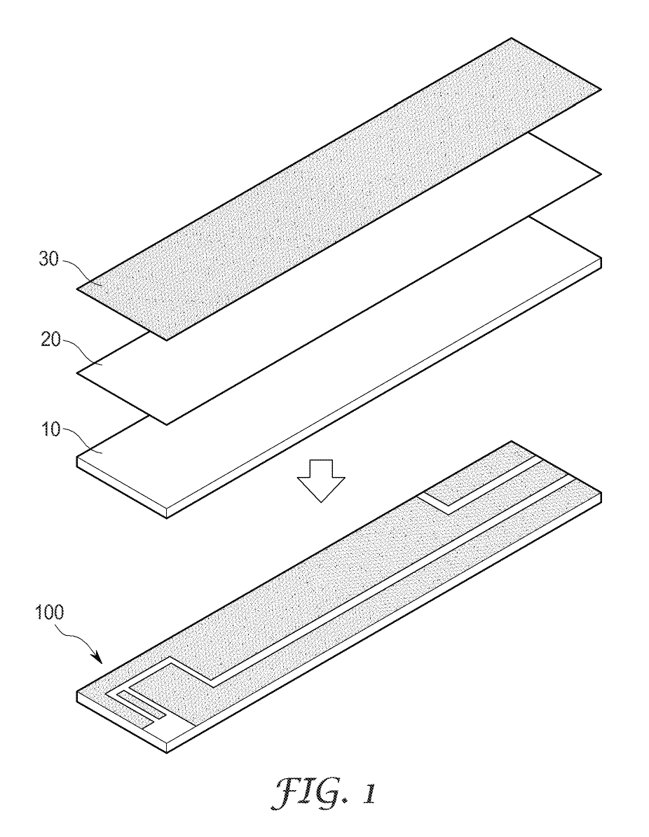

First, referring to FIG. 1, a fabrication process of an electrochemical biosensor electrode strip according to the present invention, and the structure of the electrochemical biosensor electrode strip obtained from the process will be easily understood.

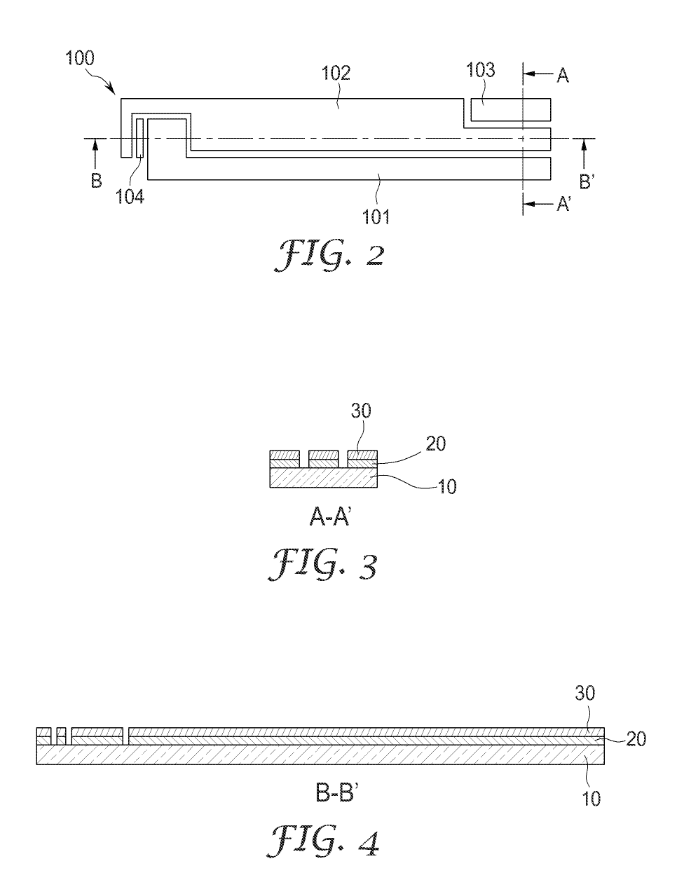

An electrochemical biosensor electrode strip 100 according to the present invention includes: a strip-shaped non-conductive substrate 10; and at least two electrodes operating as a working electrode 101 and a reference electrode 102, both shown in FIG. 2, which are provided on the substrate. The electrodes include a metal layer 20 and a carbon layer 30, and herein, the metal layer 20 is provided on the substrate 10, the carbon layer 30 is provided on the metal layer 20, and the metal layer 20 includes nickel (Ni).

FIG. 2 is a top view illustrating the electrode disposition of an electrode strip according to an embodiment of the present invention, FIG. 3 is a sectional view taken along the direction indicated by the line A-A′ as shown in FIG. 2, and FIG. 4 is a sectional view taken along the direction indicated by the line B-B′ as shown in FIG. 2.

According to an embodiment of the present invention, the metal layer 20 and the carbon layer 30 may be formed by sputtering. Through the sputtering, it is possible to form a thin film with a uniform thickness.

According to an embodiment of the present invention, each of the metal layer 20 and the carbon layer 30 may have a thickness within a range of about 200 to 2000 Å, and also may have a thickness within a range of about 500 to 1000 Å in consideration of the electrical conductivity and the ease of fabrication.

In the present invention, the metal layer 20 forming the electrode is a metal layer including nickel as a main material.

Compared to copper, nickel can form a thin film with a relatively uniform thickness, and also is safe in the reaction with a biological sample or a reagent (such as an enzyme) used for the measurement of the biological sample.

Meanwhile, nickel has a relatively high electrical conductivity, but the conductivity is not higher than the precious metal which has been conventionally used for a material of a biosensor electrode. Also, precious metals have no reactivity with a biological sample or a reagent (such as an enzyme) used for the measurement of the biological sample, while nickel shows reactivity to some extent.

In order to overcome such a weak point of nickel, in the present invention, a metal layer including nickel is previously formed on a substrate, and a carbon layer is formed thereon.

The carbon layer can complement the weak point of nickel because it has no reactivity with a biological sample or a reagent, and some conductivity.

As described above, a biosensor electrode according to the present invention is characterized in that it can show an excellent electrical property even when an expensive noble metal such as gold, silver, platinum, palladium, etc. is not used.

Meanwhile, the biosensor electrode strip according to the present invention uses a non-conductive material as the substrate 10, for example, a polymer film. Accordingly, in the present invention, in order to improve the adhesive property between the nickel and the substrate, the metal layer may include another material in addition to nickel.

According to an embodiment of the present invention, as the metal layer 20, a mixed layer of nickel and chromium may be applied. According to another embodiment of the present invention, the metal layer may be formed as a mixed layer of nickel and nickel oxide (NiO). Herein, the chromium and the nickel oxide sacrifice the electrical conductivity to some extent, but can perform a role of improving the adhesive property between the nickel with the substrate 10.

In the metal layer 20 including the mixed layer of the nickel and chromium, the content ratio of the nickel to the chromium may range from 90:10% to 50:50% by weight in consideration of the electrical conductivity and the adhesive property with the substrate.

Likewise, in the metal layer 20 including the mixed layer of the nickel and nickel oxide, the content ratio of the nickel to the nickel oxide may range from 90:10% to 50:50% by weight.

According to an embodiment of the present invention, between the working electrode 101 and the reference electrode 102, an auxiliary electrode 104 may be further formed. In this structure, a biological sample to be measured may be applied to the area with the auxiliary electrode formed thereon.

In other words, when the electrochemical biosensor electrode strip 100 according to the present invention is applied to a biosensor, a reagent, etc. having reactivity with a biological sample to be measured is placed on the area adjacent to the working electrode 101 and the reference electrode 102, or on the area where the auxiliary electrode 104 is disposed.

For example, when the electrochemical biosensor electrode strip according to the present invention is used for a kit which measures blood sugar by measuring glucose in blood, the area of the auxiliary electrode 104 may be a_reaction portion. On the reaction portion, as a reagent, any reagent based on hydrogel and glucose oxidase (hereinafter referred to a “GO”) may be placed. Herein, when a blood sample is applied to the reaction portion, glucose contained within the blood sample is oxidized by an enzymatic reaction with GO and GO is reduced. The reduced GO is re-oxidized through a reaction with an electron acceptor, and the oxidized GO reacts with another glucose. For this, the reduced electron acceptor loses electrons and is electrochemically re-oxidized by moving onto the electrode surface with voltage applied thereto, and thus continuously participates in the reaction. Since the current generated in the oxidization process of the electron acceptor is in proportion to the concentration of glucose within blood, the concentration of the glucose within the blood can be quantitatively measured by measuring the current amount between the working electrode 101 and the reference electrode 102. Meanwhile, the auxiliary electrode 104 may perform a role of promoting the electricity flow between the working electrode 101 and the reference electrode 102, and may function as an indicator for indicating a reaction portion.

Also, in consideration of the case where the electrochemical biosensor electrode strip is used by being inserted into a tester, a recognition electrode 103 for determining whether the electrode strip is properly inserted into the tester or not may be further included. For example, when the electrode strip is inserted into the tester, the tester may be configured in such a manner that the recognition electrode 103 is electrically connected to a sensing circuit additionally included in the tester.

According to an embodiment of the present invention, as the non-conductive substrate 10, a polymer film, especially an insulating polymer film, may be used. There is no limitation on the material to be used for the insulating polymer film as long as it shows an insulating property. Examples of such an insulating polymer film include a polyethylene telephthalate (PET) film, an epoxy resin film, a phenolic resin film, a polyethylene film, a polyvinyl chloride film, a polyester film, a polycarbonate film, a polystylene film, a polyimide film, etc., but the present invention is not limited thereto.

The present invention also provides a method of fabricating an electrochemical biosensor electrode strip, the method including the steps of: preparing a non-conductive substrate; forming a nickel-including metal layer on the substrate; forming a carbon layer on the formed metal layer, thereby providing a conductive layer including the metal layer and the carbon layer; and patterning an electrode shape by partially etching the conductive layer.

According to an embodiment of the present invention, a large and wide substrate can be used, and a plurality of electrode patterns is formed on one substrate, and then, the substrate is cut along with each electrode pattern to be a single independent electrode.

According to an embodiment of the present invention, the nickel (Ni)-including metal layer and the carbon layer may be formed by sputtering.

The nickel (Ni)-including metal layer may be formed by sputtering nickel and chromium at once, and herein, the sputtering ratio of the nickel to the chromium may range from 90:10% to 50:50% by weight.

According to another embodiment of the present invention, the nickel (Ni)-including metal layer may be formed by sputtering nickel and nickel oxide (NiO) at once, and herein, the sputtering ratio of the nickel to the nickel oxide may also range from 90:10% to 50:50% by weight.

Herein, each of the nickel (Ni)-including metal layer and the carbon layer may have a thickness within a range of 200 to 2000 Å through sputtering. The thickness may be adjusted in consideration of the ease in fabrication and the electrical conductivity.

After the conductive layer including the metal layer and the carbon layer is formed by the sputtering of the metal layer and the carbon layer, an electrode pattern is formed by etching. Herein, as the etching, laser etching may be applied to the present invention.

When the laser etching is used to form the electrode pattern, it is possible to simply form a micro-shaped electrode pattern. Also, unlike a general etching method using solvent, the laser etching has an advantage in that it does not generate environmental pollution caused by the solvent.

According to an embodiment of the present invention, after sputtering the total surface of the substrate, the laser etching is performed to form electrode pattern, there is no need to use a patterned mask during the sputtering.

That is, when laser etching method is used in the present invention, a direct sputtering method, a method of sputtering the total surface of the substrate at one time, can be adopted. In case of direct sputtering, there is no need to use a patterned mask during the sputtering, and roll to roll process, a process that the sputtering can be performed rolling the substrate, can be applied, and thus sputtering process is simple. As a result sputtering time becomes short production efficiency becomes high with performing a direct sputtering method followed by laser etching.

In addition, because electrode patterns can easily be formed by applying laser etching method, mass production can be achieved.

Through the etching, the working electrode 101 and the reference electrode 102 may be formed, and furthermore, at least one or more additional electrodes, such as the auxiliary electrode 104 and the recognition electrode 103, may be optionally formed.

Such an electrochemical biosensor electrode strip according to the present invention may be fabricated as shown in FIG. 1.

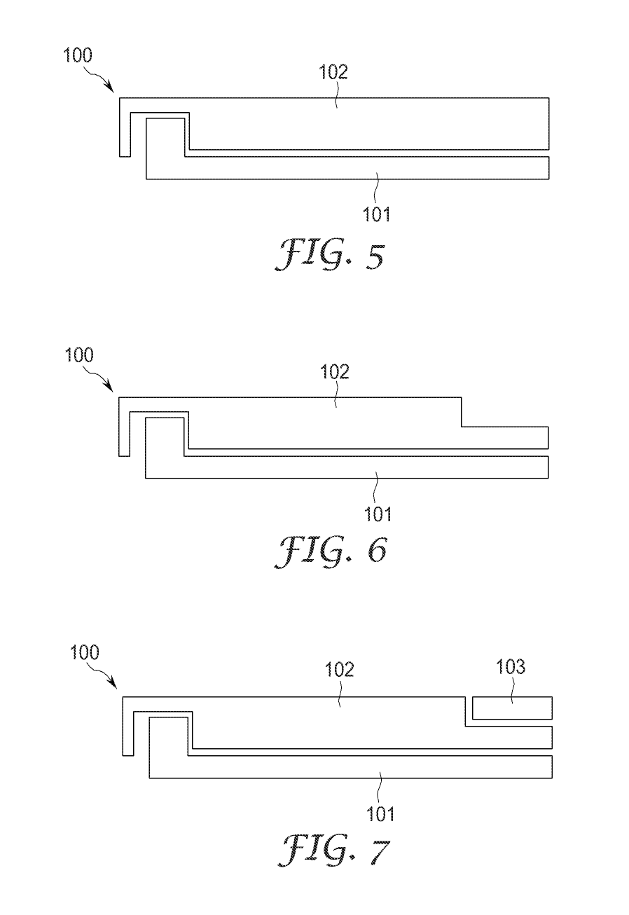

Other embodiments of the electrochemical biosensor electrode strip according to the present invention are shown in FIGS. 5 to 7.

The electrochemical biosensor electrode strips as shown in FIGS. 5 and 6 are basically-structured electrode strips, each of which includes only the working electrode 101 and the reference electrode 102.

The electrochemical biosensor electrode strip as shown in FIG. 7 is another electrode strip which includes the recognition electrode 103, in addition to the working electrode 101 and the reference electrode 102.

As described above, the electrode strip according to the present invention has an advantage in that it requires a low production cost because it is fabricated by mainly using nickel and chromium, instead of an expensive precious metal, and also using carbon. Also, since the pattern of the electrode is formed by etching a conductive layer formed on a substrate, the fabrication of the electrode is simple. Moreover, since a carbon layer is formed on a nickel-including metal layer, carbon can be uniformly applied and resistance variation of the electrode can be improved. Thus, it is possible to obtain a more reliable test result.

The electrochemical biosensor electrode strip according to the present invention may be used to measure various substances of a biological sample through the application to an electrochemical biosensor for measuring a specific substance of the biological sample. For example, the electrode strip may be used to measure glucose, uric acid, protein within blood, and also applied for DNA and liver function tests.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. An electrode strip for an electrochemical biosensor, the electrode strip comprising: a strip-shaped non-conductive substrate; and at least two electrodes operating as a working electrode and a reference electrode, which are provided on the substrate,
wherein the electrodes comprise a metal layer and a carbon layer, in which
the metal layer is provided on the substrate, the carbon layer is provided on the metal layer, and
the metal layer comprises nickel (Ni), and optionally wherein an auxiliary electrode is further provided between the working electrode and the reference electrode.

2. The electrode strip of claim 1, wherein the metal layer is a mixed layer of nickel and chromium, or a mixed layer of nickel and nickel oxide (NiO).

3. The electrode strip of claim 2, wherein a content ratio of the nickel to the chromium ranges from 90:10% to 50:50% by weight, or wherein a content ratio of the nickel to the nickel oxide ranges from 90:10% to 50:50% by weight.

4. The electrode strip of claim 1, wherein each of the metal layer and the carbon layer has a thickness within a range of 200 to 2000 Angstroms.

5. The electrode strip of claim 1, further comprising a recognition electrode.

6. A method of fabricating an electrode strip for an electrochemical biosensor, the method comprising:
preparing a non-conductive substrate;
forming a nickel (Ni)-including metal layer on the substrate;
forming a carbon layer on the formed metal layer, thereby forming a conductive layer comprising the metal layer and the carbon layer; and
patterning an electrode shape by partially etching the conductive layer.

7. The method of claim 6, wherein a ratio of the nickel to the chromium ranges from 90:10% to 50:50% by weight, or wherein a ratio of the nickel to the nickel oxide ranges from 90:10% to 50:50% by weight.

8. The method of claim 6, wherein each of the nickel (Ni)-including metal layer and the carbon layer has a thickness within a range of 200 to 2000 Angstroms.

9. The method of claim 6, wherein the electrode shape corresponds to a working electrode and a reference electrode.

10. The method of claim 9, wherein in addition to the working electrode and the reference electrode, an additional electrode shape corresponding to at least one of an auxiliary electrode and a recognition electrode is further formed.
